(19) United States
(12) Patent Application Publication
(10) Pub. No.: US 2012/0187060 A1
(43) Pub. Date: Jul. 26, 2012

(54) MODULAR DISPLAY SYSTEM

(76) Inventor: DANIEL J. CANDOS, Oak Lawn, IL (US)

(21) Appl. No.: 13/011,430

(22) Filed: Jan. 21, 2011

(51) Int. Cl. A47F 1/04; B23P 11/00

(52) U.S. Cl. 211/59.2; 29/428

(57) ABSTRACT

A modular display system includes a display fixture having a product interface adapted to support at least one product and a support fixture interface. The support fixture interface includes a base member coupled to the product interface and first and second engagement arrangements disposed along opposite sides of the base member. The display fixture is rotatable 180 degrees between first and second display positions, with the first engagement arrangement being adapted to engage a first support fixture when the display fixture is in the first display position, and wherein the second engagement arrangement is adapted to engage a second support fixture having a different configuration than the first support fixture when the display fixture is in the second display position. Various embodiments of the support fixture include a slat wall, a hang bar, a peg board and a wire grid.

### FIELD OF THE INVENTION

The present invention relates generally to a display system, and in particular, to a modular display system that is capable of interfacing with multiple support fixtures.

### BACKGROUND

It is well known to display products using various display fixtures, such as display hooks. Likewise, products, such as tools (office tools, construction tools, etc.), may be supported on such display fixtures for easy identification and access. Typically, such display fixtures are supported by a support fixture. Commonly used and available support fixtures include hang bars, slat walls, wire grids and peg boards. Typically, however, individual display fixtures are configured to engage only one type of support fixture, thereby requiring different types of display fixtures suitable for each configuration, which increases inventory and production costs.

To solve this problem, some devices have been configured to engage more than one type of support fixture, as shown for example in U.S. Pat. No. 5,582,376 to Thompson and U.S. Pat. No. 6,604,637 to Lane. The Thompson device, however, offsets the product interface from the rail in one configuration, and relies on a short flange to resist bending moments, thereby reducing the robustness of the fixture and its ability to support larger loads. Moreover, when engaged with a slat wall, the device may be easily dislodged due to the lack of any component extending upwardly into the vertical groove of the wall. Likewise, the device, when engaged with the rail, may also be easily dislodged.

Lane also suffers several deficiencies. Significantly, Lane requires a separate and releasably connectable adapter member to accommodate different support fixtures. As such, the user must again retain more than one component in inventory, thereby increasing the overall cost of the system. In addition, the user must be familiar with the system in order to properly assemble/disassemble the adapter depending on the selected end use.

Accordingly, the need remains for a modular display fixture that is capable of interfacing with a plurality of support fixtures, but does not need to be reconfigured depending on the selected support fixture.

### SUMMARY

The present invention is defined by the following claims, and nothing in this section should be considered to be a limitation on those claims.

In one aspect, one embodiment of a modular display system includes a display fixture having a product interface adapted to support at least one product and a support fixture interface. The support fixture interface includes a base member coupled to the product interface, a first engagement arrangement disposed along one end of the base member and a second engagement arrangement disposed along another end of the base member opposite the first engagement arrangement. The display fixture is rotatable 180 degrees between first and second display positions, with the first engagement arrangement being adapted to engage a first support fixture when the display fixture is in the first display position, and wherein the second engagement arrangement is adapted to engage a second support fixture having a different configuration than the first support fixture when the display fixture is in the second display position. Various embodiments of the support fixture may include a slat wall, a hang bar, a peg board and a wire grid.

Various methods of using and assembling the modular display system are also provided. For example and without limitation, in one embodiment, a method of configuring a modular display system includes providing a first support fixture, providing a display fixture having a product interface adapted to support at least one product and a support fixture interface, and engaging the first support fixture with the first engagement arrangement. The method also includes providing a second support fixture having a different configuration than the first support fixture, disengaging the first engagement arrangement from the first support fixture, rotating the display fixture 180 degrees, and engaging the second support fixture with the second engagement arrangement.

The various embodiments of the display fixture system, and the methods for the use and assembly thereof, provides significant advantages over other display fixtures. For example and without limitation, the system may interface with a plurality of different types of support fixtures without having to reconfigure or assemble the fixture. As such, only a single display fixture need be retained in inventory. At the same time, the system is extremely durable and robust.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of a display fixture.

FIG. 2 is a top view of the display fixture shown in FIG. 1.

FIG. 3 is a side view of the display fixture shown in FIG. 1.

FIG. 4 is an end view of the display fixture shown in FIG. 1.

FIG. 5 is a perspective view of the display fixture shown in FIG. 1 engaged with a hang bar.

FIG. 6 is a perspective view of the display fixture shown in FIG. 1 engaged with a slat wall.

FIG. 7 is a perspective view of another embodiment of a display fixture.

FIG. 8 is a top view of the display fixture shown in FIG. 7.

FIG. 9 is a side view of the display fixture shown in FIG. 7.

FIG. 10 is an end view of the display fixture shown in FIG. 7.

FIG. 11 is a perspective view of the display fixture shown in FIG. 7 engaged with a hang bar.

FIG. 12 is a perspective view of the display fixture shown in FIG. 7 engaged with a slat wall.

FIG. 13 is a partial perspective view of another embodiment of a display fixture.

FIG. 14 is an end view of the display fixture shown in FIG. 13 engaged with a peg board.

FIG. 15 is an alternative embodiment of a support fixture interface.

### DETAILED DESCRIPTION OF THE PRESENTLY PREFERRED EMBODIMENTS

It should be understood that the term “plurality,” as used herein, means two or more. The term “longitudinal,” as used herein means of or relating to length or the lengthwise direction. The term “lateral,” as used herein, means sideways, or substantially perpendicular to the longitudinal direction. The term “coupled” means connected to or engaged with, whether directly or indirectly, for example with an intervening member, and does not require the engagement to be fixed or permanent, although it may be fixed or permanent. The term “transverse” means extending across an axis, and/or substantially perpendicular to an axis. It should be understood that the use of numerical terms “first,” “second,” “third,” etc., as used herein does not refer to any particular sequence or order of components; for example “first” and “second” arrangements may refer to any sequence of such arrangements, and is not limited to the first and second arrangements of a particular configuration unless otherwise specified. It should be understood that the term “array” refers to two or more objects or items arranged relative to each other.

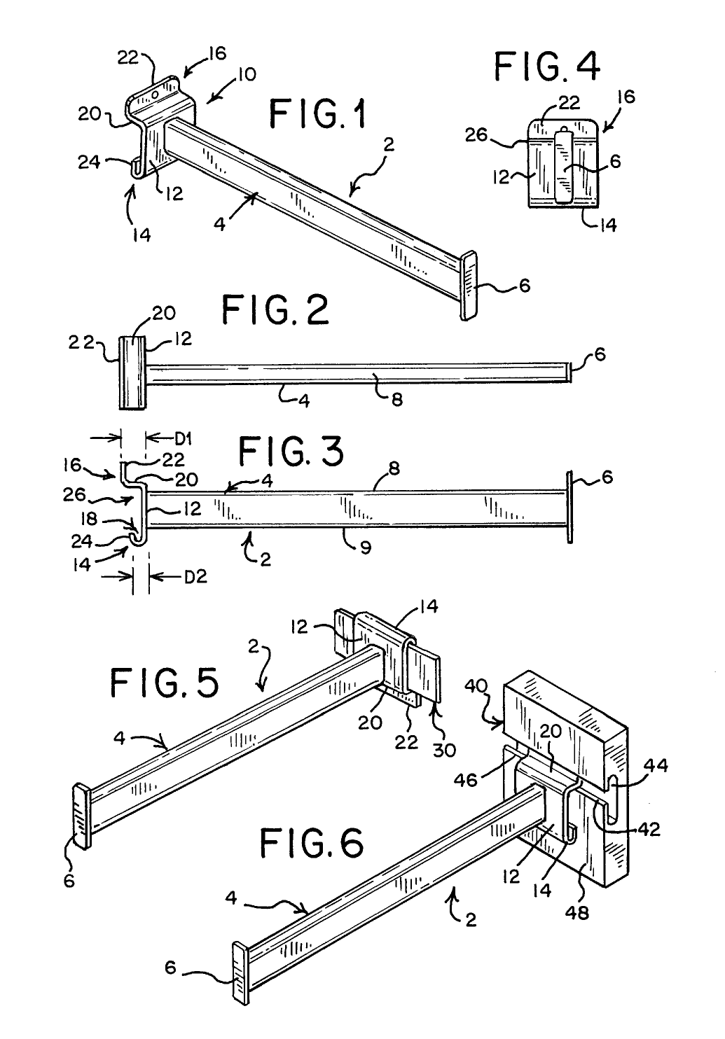

Referring to FIGS. 1-12, a display fixture 2, 102 includes a product interface 4, 104 and a support fixture interface 10. In the embodiment of FIGS. 1-6, the product interface 4 includes a bar or tube, having a rectangular cross-section in one embodiment, although it should be understood that the bar or tube may be configured with other cross-sectional shapes, including without limitation circles, squares, triangles, diamonds, other polygons, ellipses, obround, etc. In one embodiment, the interface 4 has a length of about 12.00 inches, and is formed from ½×1 inch steel tubing. An end cap 6 is secured to a free end of the interface, and extends slightly above and below the top and bottom surfaces 8, 9 of the interface. Various products, including without limitation, garments, tools, household goods, food items, etc. may be supported on the interface for example by way of hangers, tags, etc.

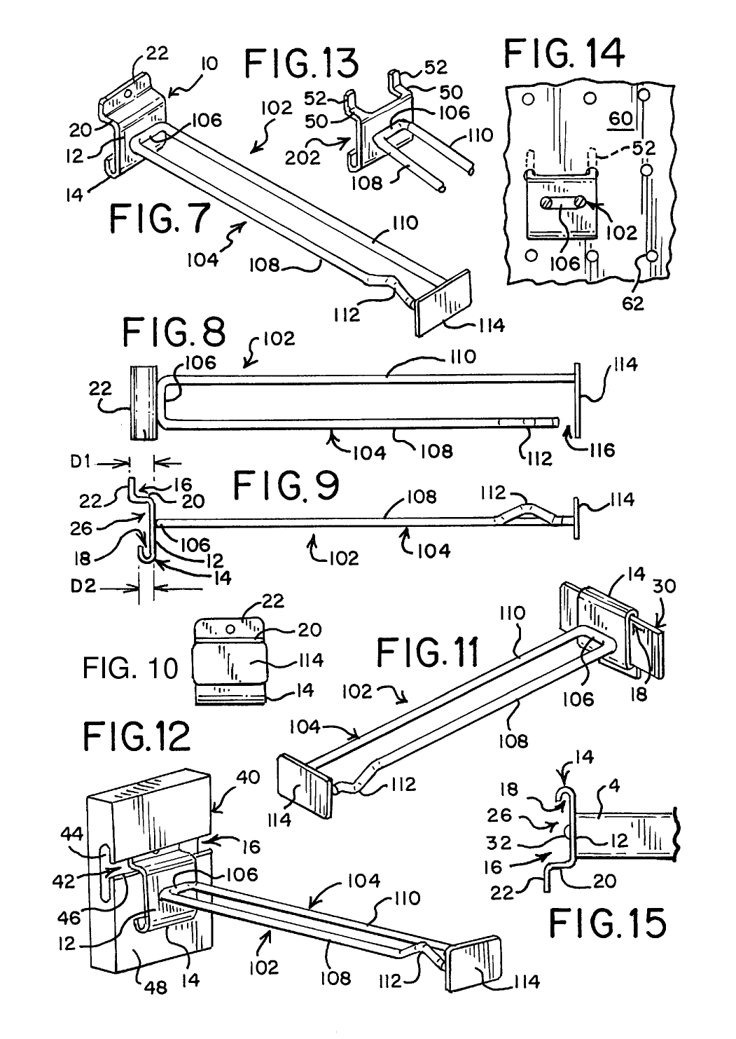

Referring to the embodiment of FIGS. 7-12, the product interface 104 is configured as a U-shaped wire, with a base portion 106 and a pair of spaced apart arm portions 108, 110. In one embodiment, the wire is 0.25 inches in diameter. In one embodiment, one of the arms 108 has a V-shaped bend 112 formed therein at an end thereof. A ticket holder 114 is secured to the end of the other arm 110 and overlies the first arm 108, with a space or gap 116 formed between the end of the arm and a backside of the ticket holder. In one embodiment, the longer arm 110 is about 12.00 inches, while the V-shaped bend 112 is positioned above 9.75 inches from the rear surface of the base portion 106. Again, various products may be supported on one or both of the arms, with some embodiments being slid on and off the arm through the gap. It should be understood that other product interface elements, including single rods or wires, hooks, clamps, etc. may be provided.

Referring back to FIGS. 1-12, the product interfaces 4, 104 are fixedly secured, for example by welding, adhesives, mechanical fasteners, snap-fit, bent tabs, etc., to the support fixture interface 10. The support fixture interface includes a base portion 12 providing a platform for attachment of the product interface 4, 104. First and second engagement arrangements 14, 16 are disposed on opposite ends of the base member, which has a height of about 1.25 inches and a width of about 2 inches in one embodiment. In one embodiment, the base portion and first and second engagement arrangements are integrally formed from a single, homogenous piece of material, preferably steel, such as 12 gauge steel (0.104 inch thick). The display fixture may be powder coated, plated, or otherwise finished as deemed appropriate.

In one embodiment, the first engagement arrangement 14 is configured as a bent flange, or hook, which defines a groove 18 opening inwardly from the end of the base member. When the display fixture is oriented in a first display position, shown in FIGS. 5 and 11, the groove 18 opens downwardly. In one embodiment, the groove 18 has an inner diameter of about 3/16 inches, while the bent flange has a vertical height of about ½ inches.

The second engagement arrangement includes a horizontal portion 20, configured as a flange in this embodiment, and a vertical insert portion 22, configured as a vertical flange in this embodiment. The flange may be configured with a hang hole, wherein the flanged may be engaged for various finishing operations. In one embodiment, the vertical and horizontal flanges 20, 22 are each bout ⅝ inches in length. When the display fixture 2, 102 is in the first display position, shown in FIGS. 5 and 11, the horizontal flange 20 underlies the hook 14 in a spaced apart relationship. Specifically, the horizontal flange 20 has a sufficient width such that the entirety of the groove 18 is covered, with the free edge 24 of the flange and the bottom of the horizontal flange 20 forming a mouth 26. Put another way, the vertical flange 22 is positioned a greater distance D1 from the rear surface of the base portion than a distance D2 of the rearwardmost surface of the bent flange 14 from the base portion 12. In this way, when the hook 14 is disposed on a first support fixture 30, shown as a flat, hang bar, the horizontal flange 20 extends under the bottom of the hang bar. In some embodiments, the space between the hook 14 and horizontal flange 20 may be set such that the horizontal flange engages the bottom of the hang bar 30 when the hook is fully engaged on the top of the hang bar.

In one embodiment, the product interface 4, 104 is angled upwardly when positioned on the hang bar 30, forming an oblique angle, for example and without limitation about 4-5 degrees, relative to a horizontal plane, such that items disposed on the product interface 4, 104 slide downwardly toward the support fixture 2, 102 interface. As shown in FIG. 15, a spacer 32, shown as a bump, may be positioned on a rear surface of the base member 12 so as to engage the front surface of the hang bar 30 and tilt the product interface 4, 104 upwardly, particularly when the display fixture is in the first display position shown in FIGS. 5 and 11. The spacer may be integrally formed as a dimple in the base member, or be otherwise applied, for example by welding, soldering, adhesives, etc.

Referring to FIGS. 6 and 12, the display fixture 2, 102 has been rotated 180 degrees to a second display position. In this position, the vertical insert portion 22 extends upwardly, wherein it may be inserted through a mouth 42 in a slat wall 40 and disposed in a vertical groove 44, with the horizontal flange 20 resting on a lower lip 46 of the mouth. A rear surface of the hook 14 engages an outer surface 48 of the wall. Due to the arrangement and spacing of the vertical insert portion 22 and hook 14, the product interface 4, 104 again is angled upwardly at an oblique angle relative to the horizontal plane, for example and without limitation at about 4-5 degrees. In this way, the product interface 4, 104 maintains an upward slope regardless of whether the display fixture is in the first or second display positions.

Referring to FIGS. 13 and 14, the horizontal portion is configured as a pair of spaced apart arms 50, with the vertical insert portion configured as a pair of spaced apart posts 52 extending upwardly from the arms 50. When the display fixture is in the first position, the horizontal arms 50 are disposed below the lower edge of the hang bar 30. In the second display position, the arms 50 and posts 52 may interface with the slat wall 40 as described above. Alternatively, as shown in FIG. 14, the support fixture may be configured as a peg board 60 having an array of openings 62 formed therethrough. During installation, the posts 52, which are spaced at the same distance as at least one pair of holes 62 in the array 60, are inserted through the pair of holes, with the display fixture 202 than rotating toward the peg board 60 such that the arms 50 rest on a bottom surface of the holes 62 with the posts 52 engaging a back side of the peg board 60. In one embodiment, the hook 14 engages a front surface of the peg board, while in another embodiment; it is spaced from the surface thereof.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A modular display system comprising:
a display fixture comprising:
a product interface adapted to support at least one product; and
a support fixture interface, said support fixture interface comprising a base member coupled to said product interface, a first engagement arrangement disposed along one end of said base member and a second engagement arrangement disposed along another end of said base member opposite said first engagement arrangement, wherein said display fixture is rotatable 180 degrees between first and second display positions, wherein said first engagement arrangement is adapted to engage a first support fixture when said display fixture is in said first display position, and wherein said second engagement arrangement is adapted to engage a second support fixture having a different configuration than the first support fixture when said display fixture is in said second display position.

2. The modular display system of claim 1 wherein said first engagement arrangement comprises a bent flange defining a groove opening downwardly when said display is in said first display position.

3. The modular display system of claim 2 wherein said second engagement arrangement comprises a horizontal portion extending from said base in a direction opposite said product interface, and a vertical insert portion extending upwardly from said horizontal flange when said display fixture is in said second display position.

4. The modular display system of claim 3 wherein said horizontal portion comprises a flange and wherein said vertical insert portion comprises a flange.

5. The modular display system of claim 3 wherein said horizontal portion comprises a pair of spaced apart arms and said vertical insert portion comprises a pair of spaced apart posts extending upwardly from said arms.

6. The modular display system of claim 3 wherein said vertical insert portion is positioned further from said base member than said bent flange.

7. The modular display system of claim 6 wherein said horizontal flange overlies said groove.

8. The modular display system of claim 1 wherein said product interface forms an oblique angle relative to a horizontal plane when in said first and second display positions.

9. A modular display system comprising:
first and second support fixtures having different configurations;
a display fixture comprising a support fixture interface, said support fixture interface comprising a base member coupled to said product interface, a first engagement arrangement disposed along one end of said base member and a second engagement arrangement disposed along another end of said base member opposite said first engagement arrangement, wherein said display fixture is rotatable 180 degrees between first and second display positions, wherein said first engagement arrangement engaged with said first support fixture when said display fixture is in said first display position, and wherein said second engagement arrangement is engaged with said second support fixture when said display fixture is in said second display position.

10. The modular display system of claim 9 wherein said first engagement arrangement comprises a bent flange defining a horizontal groove opening downwardly when said display is in said first display position, and wherein said first support fixture comprises a hang bar received in said horizontal groove.

11. The modular display system of claim 10 wherein said second engagement arrangement comprises a horizontal portion extending from said base in a direction opposite said product interface, and a vertical insert portion extending upwardly from said horizontal portion when said display fixture is in said second display position.

12. The modular display system of claim 11 wherein said horizontal portion comprises a flange and said vertical insert portion comprises a vertical flange, and wherein said second support fixture comprises a wall having at least one vertically oriented groove and a mouth opening into said vertically oriented groove, wherein said vertical flange portion is received in said vertically oriented groove as said horizontal flange extends through said mouth.

13. The modular display system of claim 11 wherein said horizontal portion comprises a pair of spaced apart arms and said vertical insert portion comprises a pair of spaced apart posts extending vertically from said arms, and wherein said second support fixture comprises a peg board wall having an array of openings, wherein said pair of spaced apart posts are disposed on an opposite side of said peg board wall with said arms extending through a pair of said openings in said peg board.

14. The modular display system of claim 11 wherein said horizontal portion comprises a pair of spaced apart arms and said vertical insert portion comprises a pair of spaced apart posts extending vertically from said arms, and wherein said wherein said second support fixture comprises a wall having at least one vertically oriented groove and a mouth opening into said vertically oriented groove, wherein said pair of spaced apart posts are received in said vertically oriented groove as said arms extend through said mouth.

15. The modular display system of claim 11 wherein said vertical insert portion is positioned further from said base member than said bent flange.

16. The modular display system of claim 15 wherein said horizontal portion overlies said horizontal groove.

17. The modular display system of claim 9 further comprising a product interface coupled to said support fixture interface, wherein said product interface is tilted upwardly relative to a horizontal plane when in said first and second display positions.

18. A method of configuring a modular display system comprising:
providing a first support fixture;
providing a display fixture comprising:
a product interface adapted to support at least one product; and
a support fixture interface, said support fixture interface comprising a base member coupled to said product interface, a first engagement arrangement disposed along one end of said base member and a second engagement arrangement disposed along another end of said base member opposite said first engagement arrangement;
engaging said first support fixture with said first engagement arrangement;
providing a second support fixture having a different configuration than said first support fixture;
disengaging said first engagement arrangement from said first support fixture;
rotating said display fixture 180 degrees; and
engaging said second support fixture with said second engagement arrangement.

19. The method of claim 18 wherein said engaging said first support fixture with said first engagement arrangement comprises engaging a hang bar with a bent flange.

20. The method of claim 19 wherein said engaging said second support fixture with a second engagement arrangement comprises engaging a slat wall with a vertical insert portion.

21. The method of claim 20 wherein said vertical insert portion comprises a flange.

22. The method of claim 20 wherein said vertical insert portion comprises a pair of spaced apart posts.

23. The method of claim 19 wherein said engaging said second support fixture with a second engagement arrangement comprises engaging a peg board with a pair of spaced apart posts.
